(19) United States
(12) Patent Application Publication
(10) Pub. No.: US 2006/0198463 A1
(43) Pub. Date: Sep. 7, 2006

(54) Device for converting a transmitted signal into a digital signal

(75) Inventor: Jean Godin, Maur-Des-Fosses (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/319,504

(22) Filed: Dec. 29, 2005

(30) Foreign Application Priority Data
Dec. 30, 2004 (FR) 0453242

(51) Int. Cl. H04L 27/20

(52) U.S. Cl. 375/295

(57) ABSTRACT

A device for converting a signal (V_{RZ}) transmitted over a communications channel into a digital signal. The transmitted signal corresponds to encoded digital data with n states, n being at least equal to two. The converter comprises means for asynchronously comparing (21) at least one parameter of the transmitted signal to at least one threshold parameter (V₀), an n-state machine (22) for forming at least one signal with at least two states (Vₐ) from at least one compared signal (V_{cmp}) at the output of the asynchronous comparison means, and means (23, 24, 25) for synchronously detecting changes of state for generating the digital signal from said at least one signal with at least two states and from a recovered clock signal (V_{CLK}).

### BACKGROUND OF THE INVENTION

The present invention relates to the field of digital transmission. To be more precise, the present invention relates to the field of converting into a digital signal a signal transmitted over a communications channel and corresponding to digital data encoded on n states.

When information is to be transmitted over a communications channel, for example an electric wire, an optical cable, or a waveguide, or by radio waves, the information is converted into a transmission signal compatible with transmission characteristics of the channel, for example the bandwidth of the channel.

Its conversion into a transmission signal conventionally also comprises an encoding step in which the digital data is encoded in the form of a digital signal with n states, n being at not less than two. That signal is called the encoded signal.

The encoded signal comprises a sequence of synchronized symbols at the timing rate of a clock, each symbol being coded on n states and occupying a time period corresponding to the period of the clock. If n is equal to 2, the symbol is called a bit and the time period is called the bit period.

The NRZ (non-return to zero), RZ (return to zero) and Manchester code formats may be mentioned, for example.

NRZ coding associates a physical magnitude or parameter, for example an electrical voltage, directly with a logical value. If n is equal to 2, a 1 bit is associated with a first level and a 0 bit is associated with a second level. By convention, the first level corresponds to a positive voltage and the second level corresponds to zero voltage. The first level may equally correspond to a zero voltage and the second level to a negative voltage.

If n is equal to 2, RZ coding associates with a 1 logical value a transition from the second level to the first level followed by a transition from the first level to the second level. A 0 logical value is simply associated with the second level, without any transition. An RZ encoded signal therefore features pulses having a width equal to a fraction of the bit period, for example half the bit period.

Manchester coding, also known as biphase coding, introduces a transition in the middle of each interval. If n is equal to 2, Manchester coding may be effected by applying the exclusive-OR (XOR) operator to a clock signal and an NRZ encoded signal corresponding to the digital data to be encoded, which produces a rising edge if the bit is a 0 bit and a falling edge otherwise. A Manchester encoded signal therefore also features pulses having a width equal to a fraction of the bit period.

The conversion into a transmission signal may include an additional step of the encoded signal modulating an electrical carrier wave.

If the channel uses an optical carrier, the encoded signal may comprise two optical power levels, for example, and transmission may be effected in the electrical baseband, i.e. without modulating an electrical sub-carrier. NRZ coding or RZ coding is conventionally used, the first level and the second level conventionally corresponding to a certain optical power and to zero optical power, respectively.

The transmission signal is transmitted over the channel and, on reception, the digital data must be recovered from the transmitted signal.

In the case of optical transmission, the transmitted optical signal is converted into an electrical signal, for example by a photodiode.

A decision circuit is then used to convert the electrical signal into a digital signal. A digital signal is a synchronized signal assuming only a finite number of values.

The decision circuit is associated with a clock recovery circuit, the recovered clock signal having a frequency substantially corresponding to the sending clock frequency. As a general rule, the decision circuit compares synchronously, on the basis of the recovered clock signal, a physical parameter, such as its electrical voltage, representing logical values of the transmitted signal, with at least one reference value referred to below as a “threshold parameter”.

FIG. 1 is a timing diagram illustrating the operation of a converter comprising a prior art decision circuit. The signals represented in FIG. 1 are electrical voltage signals and the number n of states is equal to 2.

In this example the decision circuit recovers a digital signal 13 from a transmitted signal 11 corresponding to digital data 10 encoded with the RZ format and then transmitted over a communications channel.

In each period of the clock signal 12, substantially at a predetermined time t₀(j), the decision circuit compares the voltage of the transmitted signal 11 substantially to a predetermined threshold voltage V₀. If, at the predetermined time t₀(j), the voltage of the transmitted signal 11 is greater than substantially the predetermined threshold V₀, the decision circuit evaluates the logical value of the bit as 1, i.e. in the present example the generated digital signal 13 has a voltage amplitude around a positive voltage V_{DD}. Conversely, if the voltage of the transmitted signal 11 is less than substantially the predetermined threshold voltage, the decision circuit evaluates the logical value of the bit as 0.

The predetermined time t₀(j) and the predetermined threshold voltage V₀ must be set accurately to prevent an incorrect estimate.

However, practical implementation conditions rule out setting the predetermined time t₀(j) and the predetermined threshold voltage V₀ without a time error margin Δt and a voltage error margin ΔV. Now, for relatively high data rates, and in particular for encoding in which the corresponding transmitted signals feature pulses occupying only a fraction of the bit period, the time error margin Δt may be relatively high compared to the width of the pulses of the transmitted signal 12, which leads to a significant probability of error.

As shown in FIG. 1, the decision circuit may arrive at a decision for a time-voltage pair (t₁(j+3), V₁(j+3)) inside the time error margin Δt and the voltage error margin ΔV, but for which the voltage of the transmitted signal 11 is less than the selected voltage V₁(j+3) at the selected time t₁(j+3): consequently, the decision circuit evaluates as 0 the logical value of a 1 bit.

More generally, in the case of a transmitted signal corresponding to encoded digital data with k states, a decision circuit makes its decision in each period of the recovered clock signal on the basis of a k-plet comprising a predetermined time t₀(j) and k−1 detection threshold parameters. The decision circuit evaluates the logical value of each symbol by comparing a parameter of the transmitted signal, for example the voltage or the phase, to the k−1 threshold parameters at each predetermined time t₀(j). The detection threshold parameters may typically comprise threshold voltages V₀ with i from 1 to k−1. Similarly, the predetermined time t₀(j) and the k−1 threshold parameters are set for the decision circuit with error margins such that there is a risk of the decision circuit evaluating the logical value of certain symbols incorrectly.

In the case of RZ encoding, it is known in the art to use a Bessel filter to widen the pulses, so that at relatively high frequencies the time error margin Δt of the decision circuit is relatively small compared to the width of the widened pulses. However, because of the law of energy conservation, the widened pulses at the output of the Bessel filter have a relatively low amplitude, and so the voltage error margin ΔV may be relatively high compared to the amplitude of the widened pulses, for example.

### SUMMARY OF THE INVENTION

The present invention aims to improve the reliability of such devices for converting into a digital signal a transmitted signal corresponding to encoded digital data, in particular for encoding in which pulses may occupy only a fraction of the bit period. The invention can be applied not only to the examples of modulation formats mentioned above but also to modulation formats involving simultaneous action on a plurality of physical parameters of the transmitted signal.

The present invention consists in a converter for converting into a digital signal a signal transmitted over a communications channel and corresponding to successive digital data items encoded at the timing rate of a clock and with a number of states equal to k, where k is an integer not less than 2 and is equal to a number of distinguishable states assigned to a physical parameter of the transmitted signal, the converter comprising:

means for asynchronously comparing said parameter to k−1 threshold parameters to produce at least one compared signal;

a k-state machine for forming a signal with k discrete states from said compared signal; and

means for synchronously detecting changes of state synchronized by a recovered clock signal to produce a digital signal representing changes of state of said k-state signal occurring between two successive clock periods of said recovered clock signal.

Each output of the n-state machine may change state only on the occurrence of certain characteristic portions of a compared signal, for example its rising edges. Each signal with at least two states at the output of the k-state machine may therefore feature relatively wide pulses, at the same time retaining a relatively high amplitude. The conversion of the transmitted signal into a digital signal is therefore more reliable than with the prior art decision circuits with or without Bessel filters.

The k-state machine may be asynchronous, to form at least one asynchronous signal with at least two states. The k-state machine may equally be synchronized, to form at least one synchronous signal with at least two states.

Moreover, the present invention is not limited by the nature of the signals involved. Thus the transmitted signal may be an optical signal, an electrical signal whose current is modulated or, for example, an electrical signal whose voltage or phase is modulated. The signal with at least two states may be an electrical signal, an optical signal, etc.

The asynchronous comparison means compare a single parameter of the transmitted signal with at least one threshold parameter.

Alternatively, more than one parameter of the transmitted signal may be compared. For example, digital data with four states may be encoded in binary fashion on two physical parameters of the transmission signal, for example the amplitude and the phase. The asynchronous comparison means may be used to compare independently the amplitude and the phase of the received signal corresponding to this transmission signal to a threshold amplitude and to a threshold phase, respectively. A four-state machine can process the two compared signals at the output of asynchronous comparison means to form two two-state signals, for example, or one four-state signal. Using the recovered clock signal, the digital signal is generated by means for synchronously comparing changes of state occurring between two successive clock periods of the two two-state signals or, where applicable, the one four-state signal.

The asynchronous comparison means advantageously compare the amplitude of the transmitted signal and at least one threshold amplitude: in this case the compared parameter of the transmitted signal therefore represents the difference between these amplitudes.

If the transmitted signal corresponds to encoded data with eight states, for example, the asynchronous comparison means compare the amplitude of the transmitted signal to seven threshold amplitudes, for example.

The asynchronous comparison means may comprise a comparator, for example, or any other device that may be used to compare the parameter of the transmitted signal to at least one threshold parameter.

The present invention is not limited by the nature of the parameter of the transmitted signal that is compared, however. For example, the transmitted signal may correspond to a phase-modulated signal, so that the asynchronous comparison means compare the phase of the transmitted signal to at least one threshold phase. In this case, and in the case of an optical communications channel, the asynchronous comparison means and the two-state machine may be integrated into a single circuit comprising two matched photodiodes, for example, the matched photodiodes generating two signals that are offset relative to each other, together with a circuit for comparing the phases, so as to effect balanced dual detection.

As a general rule, the present invention is not limited by the number of components used. The asynchronous comparison means, the k-state machine and the means for synchronously detecting changes of state may be combined in a single component, for example an integrated circuit or a microcontroller.

The number k of states is advantageously equal to 2. The transmitted signal then corresponds to encoded digital data with two states and the k-state machine then comprises a two-state machine. The asynchronous comparison means may be used to compare the amplitude of the transmitted signal to a single threshold amplitude.

The present invention is not limited to a number of states equal to 2, of course. Certain codes, for example the MLT3 code, generate signals with three states. Moreover, binary digital data may conventionally be grouped into the form of symbols with 2^{k} states, where k is greater than 0. The number n of states may be therefore equal to 3, 2^{k} or any other number greater than or equal to 2.

More generally, the digital data may be coded by N independent physical magnitudes (or parameters), for example, in the case of an optical signal: power; phase; and polarization; each of these magnitudes being able to take kᵢ distinct values (kᵢ typically being from 2 to 4). The number of separate states transmitted is then n, where:

$$n = {\prod }_{i = 1}^{N} {k}_{i}$$

Thus the present invention also consists in a converter for converting into a digital signal a signal transmitted over a communications channel and corresponding to successive digital data items encoded at the timing rate of a clock with n states defined by kᵢ distinguishable states respectively assigned to a plurality of independent physical parameters of the transmitted signal, characterized in that it includes a plurality of the above converters adapted to process respective physical parameters of the transmitted signal, n being the product of the number kᵢ of distinguishable states respectively associated with said physical parameters.

The communications channel advantageously comprises an optical fiber. Optical fibers allow relatively high bit rates, for example 40 gigabits per second (Gbit/s), and the present invention therefore finds a particularly advantageous application in this field.

Prior art converters including a Bessel filter also comprise additional components, for example a photodiode. Now, for relatively high bit rates, the additional components may have a relatively low cut-off frequency, and these additional components therefore have a transfer function substantially different from unity for relatively high bit rates. Consequently, the transfer function of the prior art converter is not necessarily known: there is a risk of the decision circuit selecting an n-plet with relatively high error margins relative to the accuracy of the signal at the output of the Bessel filter. There is a risk of the decision circuit evaluating the logical value of certain bits incorrectly. Moreover, the characteristics of the Bessel filter itself depend on the bit rate.

By virtue of the asynchronous comparison step and the processing effected by the machine with two or more states, the reliability of conversion in accordance with the present invention is not particularly dependent on the exact value of the data rate of the symbols of the transmitted signal.

However, the present invention is not limited by the nature of the communications channel or by the order of magnitude of the symbol rate used. The communications channel may comprise a cable or radio waves, for example.

The invention applies advantageously to the situation in which the transmitted signal corresponds to RZ encoded digital data. RZ encoding entails two transitions per bit period when the associated bit is at 1, i.e. the pulses of the transmitted signal are relatively narrow. For the same relatively high bit rate, prior art decision circuits are less reliable at recovering RZ encoded digital data than NRZ encoded digital data.

The k-state machine is then a two-state machine and advantageously comprises a T flip-flop. This kind of flip-flop has one input and one output. The value of the output changes state on each rising edge at the input, for example. Accordingly, for a transmitted signal corresponding to RZ encoded digital data, the two-state asynchronous signal formed at the output of the T flip-flop retains the same value between two rising edges of the compared signal, i.e. between two 1 bits.

A T flip-flop is particularly well adapted to RZ encoding, as the two-state asynchronous signal comprises pulses of width not less than substantially one bit period, thereby facilitating subsequent detection of the logical values of the bits.

The synchronous change of state detection means advantageously comprise synchronization means and change of state detection means.

The synchronization means and the change of state detection means may be sequential or interleaved.

The synchronization means may comprise a sampling circuit receiving the asynchronous two-state signal and triggered by the recovered clock signal, for example.

The synchronization means advantageously comprise a first D flip-flop for forming a first synchronized binary signal, said first D flip-flop receiving at its input said two-state signal and being synchronized by the recovered clock signal, and the change of state detection means comprise:

a second D flip-flop for forming a second synchronized binary signal, said second D flip-flop receiving at its input said first synchronized binary signal and being synchronized by the recovered clock signal; and

an exclusive-OR gate receiving said first and second synchronized binary signals at its inputs and forming said digital signal at its output.

An implementation of the above kind, described here by way of example, provides at its output a digital signal in which each 1 bit is represented by a first level and each 0 bit is represented by a second level during the bit period. This digital signal may be used without additional shaping in a digital electronic circuit, for example a demultiplexer circuit or a microprocessor.

The converter advantageously uses bipolar technology. Bipolar technology, and in particular silicon-germanium or indium phosphide technology, produces a converter able to process relatively high bit rates.

The present invention is not limited by the nature of the technology used, of course. The converter may employ the BiCMOS, CMOS or HEMT technology, for example.

The present invention also consists in a device for receiving a signal received at the output of a communications channel, the received signal being a transmitted signal corresponding to encoded digital data with several states, this device comprising:

a decision circuit synchronized by the recovered clock signal for synchronously comparing a parameter of the transmitted signal to at least one threshold parameter and able to produce a resultant first digital signal;

a converter as described above able to produce a second digital signal in response to the transmitted signal; and

selection means for selecting said first or said second digital signal.

A receiver device of the above kind combines a conventional decision circuit with the converter of the present invention so that the transmitted signal may be converted into a digital signal by the most appropriate device, selected from at least the decision circuit and the converter. For example, the appropriate device may be selected as a function of the nature of the encoding of the digital data, the bit rate, etc.

The means for selecting the device actually generating the digital signal may comprise a first device and a second device, for example. The first device forwards the value of a field of the received signal to the second device, which effects a selection from the appropriate device to an output of the receiver device according to the value of the field.

Alternatively, the means for selecting the device actually generating the digital signal may comprise a jumper so that selection is manual.

Alternatively, the means for selecting the appropriate device may comprise a programmable register, for example, whose value indicates which device must be used for actually generating the digital signal.

### BRIEF DESCRIPTION OF THE DRAWINGS

The invention is described in more detail below with reference to figures showing a preferred embodiment of the invention.

FIG. 1, already commented on, is a timing diagram illustrating the operation of a converter comprising a prior art decision circuit.

FIG. 2 is a diagram of a preferred embodiment of a converter of the present invention.

FIG. 3 is a timing diagram illustrating the operation of the preferred embodiment of the converter of the present invention.

FIG. 4 is a diagram of a receiver device comprising another embodiment of a converter of the present invention.

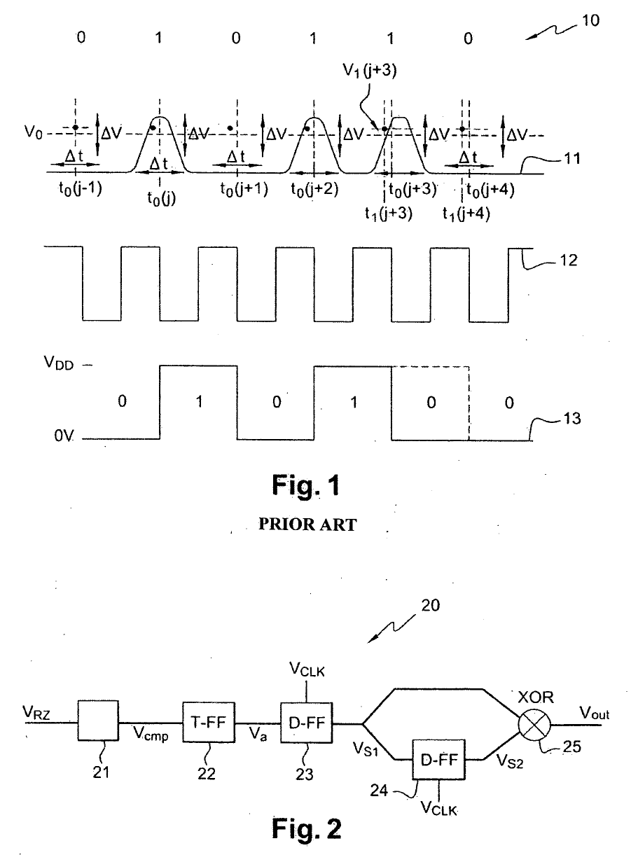

Note that, in FIGS. 2, 3, and 4, elements or portions that are identical or similar are designated by the same reference signs.

### DETAILED DESCRIPTION OF THE INVENTION

The preferred embodiment of the converter of the present invention shown in FIG. 2 converts into a digital signal a signal transmitted in baseband over an optical fiber and corresponding to RZ encoded digital data with two states. The transmitted signal V_{RZ} is an electrical signal whose voltage is modulated and which is processed by a photodiode, not shown, and an amplifier, also not shown, for example.

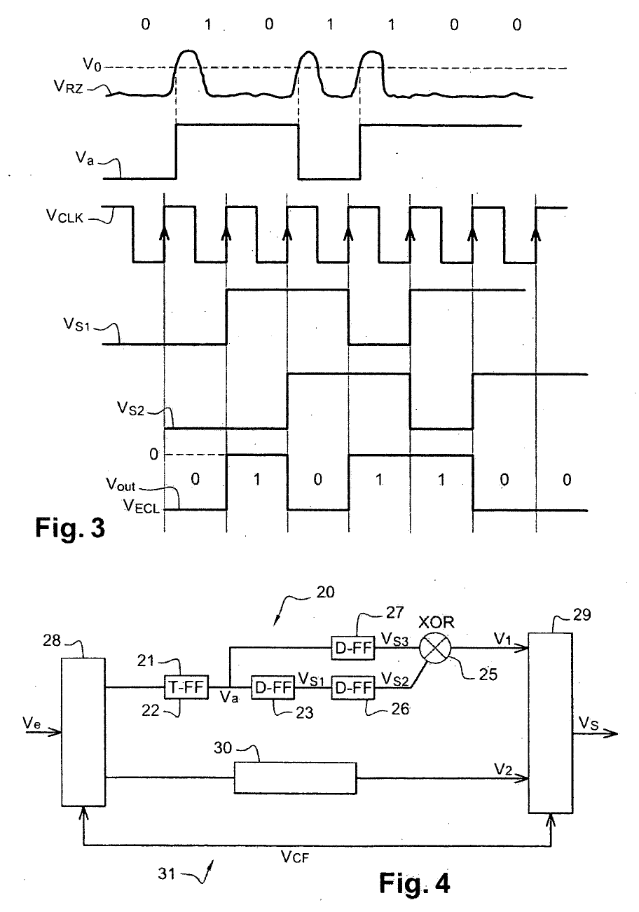

The converter 20 comprises asynchronous comparison means 21, for example a comparator, for comparing the voltage of the transmitted signal V_{RZ} to a threshold voltage V₀. The compared signal V_{cmp}, which is not shown in FIG. 3 but represents the difference between the voltage levels of the transmitted signal V_{RZ} and the threshold voltage V₀, is sent to an input of a two-state machine 22, here a T flip-flop.

The T flip-flop 22 supplies an asynchronous signal Vₐ with two discrete states and toggles from one state to the other on rising edges of the compared signal V_{cmp}. The two-state asynchronous signal Vₐ at the output of the T flip-flop 22 therefore changes state each time that the voltage of the transmitted signal V_{RZ} increases substantially above the threshold voltage V₀.

Except during transition times, the asynchronous two-state signal Vₐ takes substantially only two values in time periods at least equal to a bit period, thereby facilitating the decision as to the logic values of the bits.

The synchronous detection means comprise two D flip-flops 23, 24 and an exclusive-OR logic gate 25.

A clock recovery circuit, not shown, recovers a clock signal V_{CLK} having a frequency substantially corresponding to the bit rate of the transmitted signal V_{RZ}.

A first D flip-flop 23 synchronized by the recovered clock signal V_{CLK} and receiving the two-state asynchronous signal Vₐ at its input forms a first synchronized binary signal V_{S1}.

A second D flip-flop 24 synchronized by the recovered clock signal V_{CLK} and receiving the first synchronized binary signal V_{S1} at its input forms a second synchronized binary signal V_{S2} corresponding to the first synchronized binary signal V_{S1} time-shifted by one period of the recovered clock signal V_{CLK}.

The exclusive-OR gate 25 receiving at its inputs the first and second synchronized binary signals V_{S1} and V_{S2} forms the digital signal Vₒᵤₜ, which represents changes of state of the two-state asynchronous signal Vₐ between two successive clock periods of the recovered clock signal. It may be used without additional shaping in a digital electronic circuit, for example a time-division demultiplexer or a microprocessor.

The preferred embodiment of the converter 20 of the present invention comprises components known in the art that the person skilled in the art knows how to implement, namely the T flip-flop, the D flip-flops and the exclusive-OR gate. For relatively high bit rates, of the order of 40 Gbit/s, these components may be integrated into a single integrated circuit. Bipolar transistors may be used. In this case, each 1 bit of the digital signal Vₒᵤₜ is represented by a substantially null voltage and each 0 bit is represented substantially by a negative voltage −V_{ECL} during the bit period, for example.

The foregoing description concerns the particular situation in which, to code the digital data, the amplitude of the signal is the only physical parameter used and only two states are assigned to that parameter. For situations in which another parameter is used, the transposition simply consists in replacing the voltage comparison means 21 with comparison means adapted to the selected parameter, for example a phase comparator if the parameter is the phase.

If the choice is also made to encode the data by means of a plurality of physical parameters (such as amplitude and phase), where applicable with more than two states for at least one of the parameters, the converter may include a plurality of circuits in parallel respectively adapted to compare selected parameters, where applicable with a plurality of thresholds. The T flip-flop 22 is replaced by a multiple state machine (sometimes known as a “multi-valued memory”).

Details of such devices are given in the following references, for example:
Multiple peak resonant tunnelling diode for multi-valued memory, Wei, S.-J., Lin, H. C., Multiple-Valued Logic, 1991, Proceedings of the Twenty-First International Symposium on, Vol., Iss., 26-29 May 1991, Pages 190-195.
Vertical integration of structured resonant tunnelling diodes on InP for multi-valued memory applications, Kao, Y. C., Seabaugh, A. C., Yuan, H. I., Indium Phosphide and Related Materials, 1992, Fourth International Conference on, Vol., Iss., 21-24 April 1992, Pages 489-492.

Similarly, the logical processing necessary for identifying the change of state (performed when n=2 by the D flip-flops and the exclusive-OR gate) may be computed and implemented as disclosed in reference works such as, for example:
Computer Science and Multiple-Valued Logic, Theory and Applications, edited by David C. Rine, North-Holland Publishing Company, 1977 (and in particular chapter 2 “Logic Design and Switching Theory” and chapter 4 “Physical Components and Implementation”).

FIG. 4 is a diagram of a receiver device comprising another embodiment of a converter of the present invention.

The receiver device 31 comprises a converter 20 of the invention and a conventional decision circuit 30. The converter 20 and the decision circuit 30 generate digital signals V1 and V2, respectively.

The converter 20 and the decision circuit 30 use recovered clock signals that are not shown in FIG. 4.

The decision circuit 30 synchronously compares the amplitude of the transmitted signal to a threshold amplitude.

A received signal V_{θ} at the output of a communications channel may convey a signaling message comprising a field V_{CF} dedicated to the transmitted signal corresponding to encoded digital data, for example. The field V_{CF} indicates which type of conversion must be effected on the transmitted signal. For example, for relatively high bit rates, the prior art decision circuit 30 may be relatively unreliable for converting a signal corresponding to RZ encoded digital data, but nevertheless achieve relatively correct conversion of a signal corresponding to NRZ encoded digital data. The field V_{CF} may therefore contain an indication as to the nature of the encoding (RZ or NRZ), for example. A first device 28 transmits the field V_{CF} directly to a second device 29. The second device 29 receives the digital signals V1 and V2 from the converter 20 and from the decision circuit 30, respectively. The second device uses the value of the transmitted field V_{CF} to select the appropriate device from the decision circuit 30 and the converter 20. An output signal V_{S} is formed from the pertinent digital signal.

In the case of RZ encoded data, the first digital signal V1 at the output of the converter 20 is selected.

In the embodiment represented in FIG. 4, the conversion circuit 20 comprises a T flip-flop with integrated asynchronous comparison means 21, for example comparators, and a two-state machine 22. It is known in the art to produce a T flip-flop from logic gates, into which the comparators may be integrated, for example.

Moreover, a two-state asynchronous signal Vₐ at the output of the T flip-flop is sent to a first D flip-flop 23 followed by a second D flip-flop 26, and also to a third D flip-flop 27. The first D flip-flop and the second D flip-flop 26 form a second synchronized binary signal V_{S2}. The third D flip-flop 27 produces a third synchronized binary signal V_{S3}. The second synchronized binary signal V_{S2} is therefore offset by one bit period relative to the third synchronized binary signal V_{S3}.

The exclusive-OR gate 25 forms the first digital signal V1 from the second synchronized binary signal V_{S2} and the third synchronized binary signal V_{S3}.

1. A converter (20) for converting into a digital signal (Vₒᵤₜ) a signal (V_{RZ}) transmitted over a communications channel and corresponding to successive digital data items encoded at the timing rate of a clock and with a number of states equal to k, where k is an integer not less than 2 and is equal to a number of distinguishable states assigned to a physical parameter of the transmitted signal, the converter comprising:
means (21) for asynchronously comparing said parameter to k−1 threshold parameters (V₀ . . . Vₖ₌₂) to produce at least one compared signal (V_{cmp});
a k-state machine (22) for forming a signal with k discrete states (Vₐ) from said compared signal (V_{cmp}); and
means (23, 24, 25) for synchronously detecting changes of state synchronized by a recovered clock signal (V_{CLK}) to produce a digital signal (Vₒᵤₜ) representing changes of state of said k-state signal occurring between two successive clock periods of said recovered clock signal.

2. A converter (20) according to claim 1, wherein k is equal to two.

3. A converter (20) according to claim 2, wherein the transmitted signal (V_{RZ}) corresponds to RZ encoded digital data.

4. A converter (20) according to claim 3, wherein the two-state machine (22) comprises a T flip-flop.

5. A converter (20) according to claim 1, wherein the means (23, 24, 25) for synchronously detecting changes of state comprise synchronization means and
means for detecting changes of state.

6. A converter (20) according to claim 5, wherein the synchronization means comprise a first D flip-flop (23) for forming a first synchronized binary signal (V_{S1}), said first D flip-flop receiving said two-state signal (Vₐ) at its input and being synchronized by the recovered clock signal (V_{CLK}), and the change of state detection means comprise:
a second D flip-flop (24) for forming a second synchronized binary signal (V_{S2}), said second D flip-flop receiving said first synchronized binary signal (V_{S1}) at its input and being synchronized by the recovered clock signal (V_{CLK}); and
an exclusive-OR gate (25) receiving said first and second synchronized binary signals (V_{S1}, V_{S2}) at its inputs and forming said digital signal (Vₒᵤₜ) at its output.

7. A converter (20) according to claim 1, wherein the asynchronous comparison means (21) compare the amplitude of the transmitted signal and at least one threshold amplitude.

8. A converter (20) according to claim 1, wherein the converter is implemented in bipolar technology.

9. A converter for converting into a digital signal (Vₒᵤₜ) a signal (V_{RZ}) transmitted over a communications channel and corresponding to successive digital data encoded at the timing rate of a clock with n states defined by kᵢ distinguishable states respectively assigned to a plurality of independent physical parameters of the transmitted signal, characterized in that it comprises a plurality of converters according to claim 1 adapted to process respective physical parameters of the transmitted signal, n being the product of the number kᵢ of distinguishable states respectively associated with said physical parameters.

10. A device (31) for receiving a received signal at the output of a communications channel, the received signal (Vₑ) being a transmitted signal corresponding to encoded digital data with a plurality of states, comprising:
a decision circuit (30) synchronized by the recovered clock signal (V_{CLK}) for synchronously comparing a parameter of the transmitted signal with at least one threshold parameter and adapted to produce a first resultant digital signal (V₂);
a converter (20) according to claim 1 adapted to produce a second digital signal (V₁) in response to the transmitted signal; and
selection means (28, 29) for selecting said first digital signal (V₂) or said second digital signal (V₁).
